(19) United States
(12) Patent Application Publication
(10) Pub. No.: US 2026/0121345 A1
(43) Pub. Date: Apr. 30, 2026

(54) POWER CONNECTOR, CABLE HARNESS AND POWER CONNECTOR SET

(71) Applicant: BIZLINK INTERNATIONAL CORP., New Taipei City (TW)

(72) Inventors: Rican WANG, New Taipei City (TW); Chubei ZHANG, New Taipei City (TW); Xiangwu WANG, New Taipei City (TW)

(21) Appl. No.: 19/433,092

(22) Filed: Dec. 26, 2025

Related U.S. Application Data
(63) Continuation-in-part of application No. 18/951,693, filed on Nov. 19, 2024.
Application No. 18/951,693 is a continuation-in-part of application No. 17/858,064, filed on Jul. 5, 2022, now Pat. No. 12,224,518.

(30) Foreign Application Priority Data
Jul. 6, 2021 (CN) 202110761128.X
Nov. 15, 2021 (CN) 202122792114.2
Dec. 26, 2024 (CN) 202411942018.3

(51) Int. Cl. H01R 13/629

(52) U.S. Cl. CPC H01R 13/629

(57) ABSTRACT

A first power connector includes a housing and three terminals. A front portion of the housing has a first outer wall surrounding three terminal seats and a partition wall, and the partition wall and the first outer wall defines a retraction tunnel. The housing has a latch one piece formed with the first outer wall, the latch is formed as part of the first outer wall defining the retraction tunnel and is adopted to be sunk into the retraction tunnel when an external force is applied thereto. In addition, three terminals are secured in the three terminal seats respectively, and the retraction tunnel has no terminal disposed therein.

### RELATED APPLICATIONS

This application claims priority to Chinese Patent Application No. 202411942018.3, filed on Dec. 26, 2024, and is a Continuation-in-part of U.S. application Ser. No. 18/951,693, filed on Nov. 19, 2024, which is a Continuation-in-part of U.S. application Ser. No. 17/858,064, filed on Jul. 5, 2022, now U.S. Pat. No. 12,224,518, issued Feb. 11, 2025, which claims priority of Chinese Application Serial Number 202110761128.X, filed on Jul. 6, 2021, and Chinese Application Serial Number 202122792114.2, filed on Nov. 15, 2021, the entirety of which is incorporated by reference herein in their entireties.

### BACKGROUND

### Technical Field

The present disclosure relates to power connector sets, each of which has at least one first power connector and a second power connector connected with the first power connector. More particularly, the present disclosure relates to high current connectors.

### Description of Related Art

In the US patent US2023/0011560A1, a first connector and a second connector are disclosed. The second connector is configured to be connected with the first connector. The first connector has three terminal holes on its front end surface, each of the terminal holes is configured to allow a terminal of the second connector to be inserted therein. The first and second connector are secured with each other by the latch and fixture formed on the outer surface thereof respectively.

### SUMMARY

One of the technical aspects of the present disclosure is to provide a pair of high-power connectors for providing power to, for example, server rack. By integrating the latch and fixture into the connector housing, the overall volume of the first and second end connectors can be effectively reduced, allowing more connectors to be inserted within limited space.

According to an embodiment of the present disclosure, a power connector set including a pair of connectors is disclosed. The power connector set is designed to minimize dimensions and enable effective connectivity, particularly in space-constrained environments like server racks.

One of the power connectors comprises a rectangular outer wall, terminal seats, a retraction tunnel, and a latch hook. The terminals are arranged both horizontally and vertically to optimize space utilization. The other power connector features a rectangular outer wall, terminal seats, an engagement cavity, and a latch opening, with partition walls enhancing structural integrity. An unique centrosymmetric design enables inverted connections, maximizing compatibility. Furthermore, compact dimensions (width<30 mm, height 35-40 mm) make the power connectors suitable for server racks, providing high-current power to electronic devices efficiently.

### BRIEF DESCRIPTION OF THE DRAWINGS

The disclosure can be more fully understood by reading the following detailed description of the embodiments, with reference made to the accompanying drawings as follows:

FIG. 1 is a schematic view of a power connector set according to an embodiment of the present disclosure, in which two first power connectors and a second power connector are connected together;

FIG. 2 is a schematic view of a power connector set according to another embodiment of the present disclosure, in which the first power connector and the second power connector are separated from each other;

FIG. 3 is a schematic perspective view of the first power connector of the power connector set;

FIG. 4 is a schematic perspective view of the second power connector of the power connector set;

FIG. 5 is a schematic enlarged cross-sectional view of the power connector set; and

FIG. 6 is a schematic perspective view of the second terminal set and the shrapnel stopping pin of the second power connector according to one embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

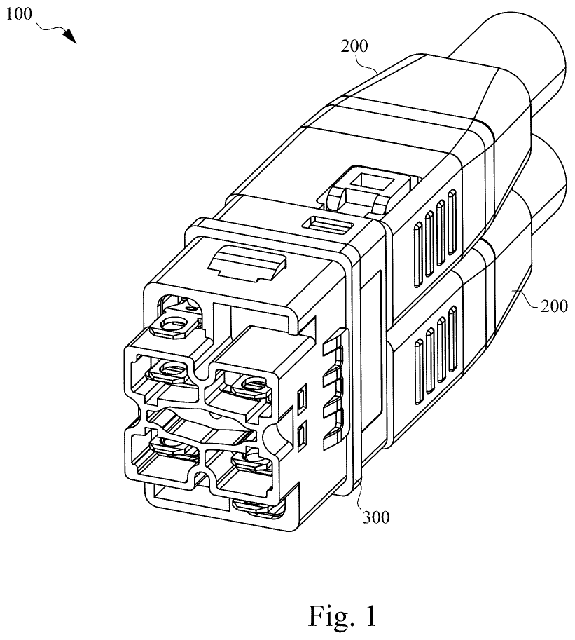

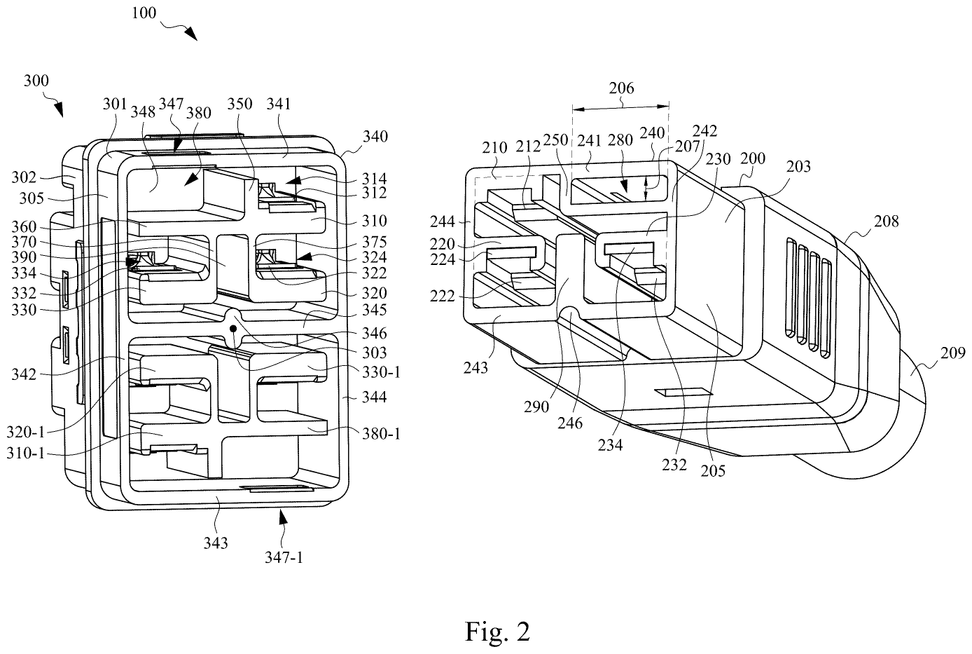

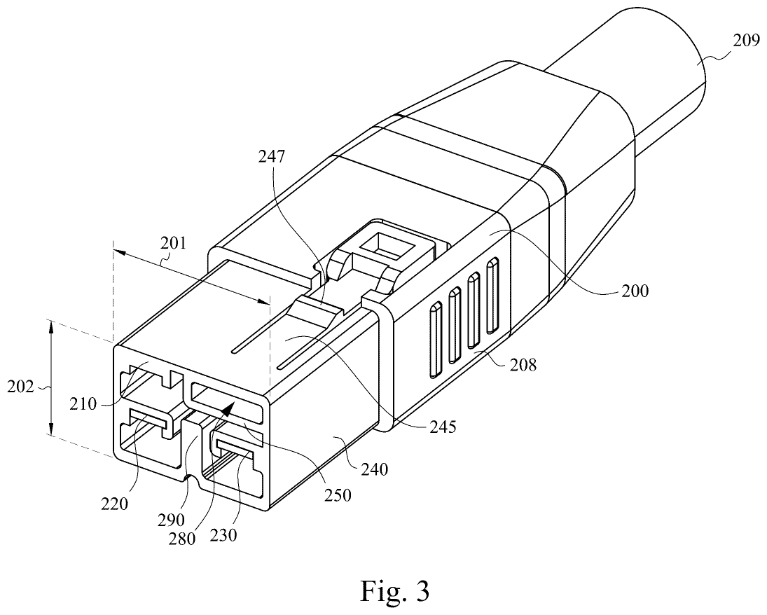

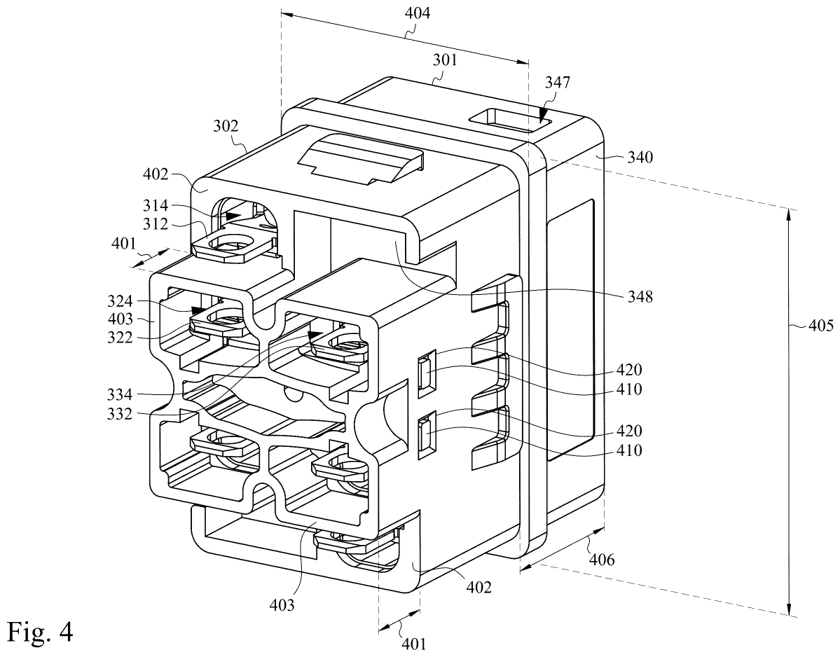

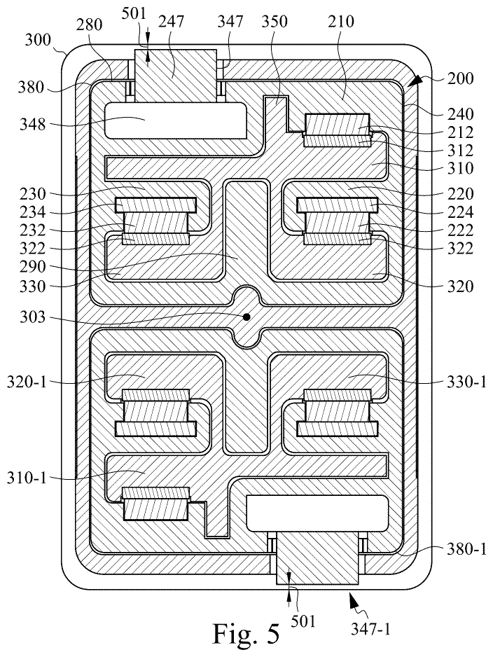

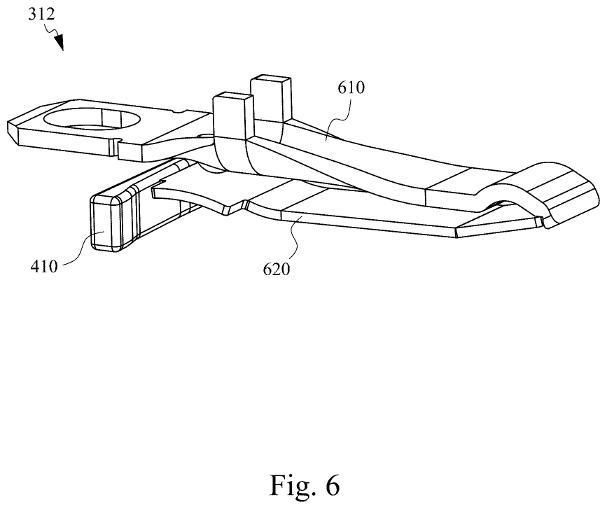

FIG. 1 illustrates a power connector set according to an embodiment of the present disclosure, in which two first power connectors and a second power connector are connected together. FIG. 2 illustrates a power connector set according to another embodiment of the present disclosure, in which the first power connector and the second power connector are separated from each other. FIG. 3 illustrates a schematic perspective view of the first power connector of the power connector set. In addition, FIG. 4 illustrates a schematic perspective view of the second power connector of the power connector set, FIG. 5 illustrates a schematic enlarged cross-sectional view of the power connector set and FIG. 6 illustrates a schematic perspective view of the second terminal set and the shrapnel stopping pin of the second power connector according to one embodiment of the present disclosure.

Furthermore, if the description in this specification is insufficient to explain the detailed design of the elements and makes it uneasy to implement, please take the electrical connector disclosed in the Chinese patent 202410137132.2 as a reference.

As shown in FIGS. 1-6, a power connector set 100 is provided in the present disclosure. Moreover, for example, the power connector set 100 is utilized for electrical connection of high current.

As shown in FIG. 1, the power connector set 100 includes a second power connector 300 and at least one first power connector 200 connected to the second power connector 300. In one or more embodiments of the present disclosure, for example, two first power connectors 200 are connected to the second power connector 300.

Referring to FIGS. 2, 3 and 5, a first power connector 200 includes a housing 203 for accommodating a first terminal 212, a second terminal 222, a second isolation plate 224, a third terminal 232, a third isolation plate 234.

The housing 203 has a retraction tunnel 280 surrounded by a first outer wall 240, a first terminal seat 210, a second terminal seat 220, a third terminal seat 230. A first partition wall 290 formed in the first outer wall 240 and connected to the first outer wall 240 respectively.

The second terminal seat 220 and the third terminal seat 230 are arranged horizontally, the first terminal seat 210 and the second terminal seat 220 are arranged vertically, the retraction tunnel 280 and the first terminal seat 210 are arranged horizontally, and the retraction tunnel 280 and the third terminal seat 230 are arranged vertically.

In one or more embodiments of the present disclosure, the first outer wall 240 includes a first side wall 241, a second side wall 242 connected to the first side wall 241, a third side wall 243 connected to the second side wall 242 and a fourth first side wall 244 connected to the third side wall 243 so as to form a rectangular first outer wall.

In one or more embodiments of the present disclosure, an L-shaped partition wall 250 is connected to a corner formed by the first side wall 241 and the second side wall 242 to form the retraction tunnel 280 having a hollow space therein. In another way, the contour of the retraction tunnel 280 on the first end surface of the first outer wall 240 is a closed rectangular without lateral exit.

As depicted in the FIG. 3, the first outer wall 240 further includes a latch 245 with a latch hook 247 one pieced formed with the first side wall 241. The latch hook 247 and the retraction tunnel 280 are arranged vertically, and therefore the latch hook 247 is located vertically above the retraction tunnel 280. The latch hook 247 may sink below the outer surface of the first side wall 241 and enters the rectangular hollow space in the retraction tunnel 280.

In one or more embodiments of the present disclosure, the first terminal seat 210 and the second terminal seat 220 are arranged vertically aligned, with the terminal in the first terminal seat 210 being a ground terminal and the terminal in the second terminal seat 220 being a live terminal, and the third terminal seat 230 and the retraction tunnel 280 are arranged vertically. In addition, the width of the retraction tunnel 280 occupies more than 40% of the width of the front portion 205 of the housing 203. Furthermore, the width 206 of the opening of the retraction tunnel 280 is at least three times of the height 207 thereof.

As depicted in the FIG. 3, in the status that the connector 200 is assembled with wire to be a cable harness, the terminals of the connector 200 are welded with wires in cable respectively and the rear end of the housing 203 of the connector 200 and at least a portion of an end of the cable are covered by an overmolded protection layer, an end of the latch 245 are not covered and exposed from the overmolded protection layer.

By integrating the latch 245 with the first outer wall 240 of the first power connector 200 and preserving sinking space by the retraction tunnel 280, the size of the first power connector 200 can be effectively reduced.

In detail, as shown in FIG. 3, the first outer wall 240 has a width 201 of 22.3 mm, and a height 202 is 15.95 mm. As an alternative, the width 201 may less than 23 mm and preferably within the range of either 15 to 23 mm or 21 to 23 mm, and the height 202 should be no more than 16 mm, and preferably within the range of 13 to 16 mm or 15.5 to 16 mm.

In one or more embodiments of the present disclosure, the cable harness has the first power connector 200, a cable 209 having a plurality of wires, electricity connected with the terminals respectively, an overmolded piece 208 covering at least a portion of the rear portion of the housing 203 and the cable 209, and a rear end of the latch 245 being not covered by the overmolded piece 208.

The first terminal seat 210, the second terminal seat 220 or the third terminal seat 230 may be a U-shaped isolation seat, but not limited thereto. The first partition wall 290 formed inside the third side wall 243 and located between and separating the second terminal seat 220 and the third terminal seat 230.

As depicted in FIG. 2, the third side wall 243 further includes a recess 246 formed outside the third side wall 243.

In the present embodiment, the first terminal 212 is a ground terminal, and the second terminal and the third terminal are either a live terminal or a neutral terminal. The first terminal 212 is fixed with the first terminal seat 210. The second terminal 222 is fixed in the second terminal seat 220 and a second isolation plate 224 is disposed between the second terminal seat 220 and the second terminal 222. The third terminal 232 is fixed with the third terminal seat 230 and a third isolation plate 234 is disposed between the third terminal seat 230 and the third terminal 232.

Referring to FIGS. 2, 4 and 5, a second power connector 300 includes a rear body 302 and a front portion 305 connected to the rear body 302. In one or more embodiments of the present disclosure, the front portion 305 includes a second outer wall 340, a fourth terminal seat 310, a fifth terminal seat 320, a sixth terminal seat 330 and an engagement cavity 380.

The second outer wall 340 is connected to the rear body 302. In addition, the fourth terminal seat 310, the fifth terminal seat 320 and the sixth terminal seat 330 are connected to the rear body 302 and located in the second outer wall 340. Furthermore, the engagement cavity 380 is arranged horizontally with the fourth terminal seat 310, and the engagement cavity 380 is arranged vertically with the sixth terminal seat 330. In addition, the fourth terminal seat 310 is arranged vertically with the fifth terminal seat 320, and the fifth terminal seat 320 is arranged horizontally with the sixth terminal seat 330.

In one or more embodiments of the present disclosure, the second power connector 300 further includes a first partition wall 350 connected to the rear body 302 and located between the fourth terminal seat 310 and the engagement cavity 380.

In one or more embodiments of the present disclosure, the second power connector further includes a second partition wall 360 connected to the rear body 302 and the first partition wall 350. In one or more embodiments of the present disclosure, the second partition wall 360 is located between the sixth terminal seat 330 and the engagement cavity 380.

In one or more embodiments of the present disclosure, the second power connector 300 further includes a third partition wall 370 connected to the rear body 302 and the sixth terminal seat 330, and a fourth partition wall 375 connected to the rear body 302 and the fifth terminal seat 320. In addition, the second power connector 300 further includes an isolation cavity 390 preferably located between the third partition wall 370 and the fourth partition wall 375.

It is worth noting that the second outer wall 340 includes a fourth side wall 341, a second side wall 342 connected to the fourth side wall 341, a sixth side wall 343 connected to the second side wall 342, a fourth second side wall 344 connected to the sixth side wall 343 to form a rectangular second outer wall.

In one or more embodiments of the present disclosure, the second outer wall 340 further includes an intermediate partition wall 345 connected between the second side wall 342 and the fourth second side wall 344.

In one or more embodiments of the present disclosure, the fourth side wall 341 further includes a latch opening 347 formed vertically above the engagement cavity 380.

In one or more embodiments of the present disclosure, the second power connector 300 further includes a centrosymmetric fourth terminal seat 310-1, a centrosymmetric fifth terminal seat 320-1, a centrosymmetric sixth terminal seat 330-1, a centrosymmetric engagement cavity 380-1 and a centrosymmetric latch opening 347-1. The centrosymmetric fourth terminal seat 310-1, the centrosymmetric fifth terminal seat 320-1 and the centrosymmetric sixth terminal seat 330-1 are connected to the rear body 302 and located in the second outer wall 340. The centrosymmetric engagement cavity 380-1 is arranged horizontally with the centrosymmetric fourth terminal seat 310-1, and the centrosymmetric engagement cavity 380-1 is arranged vertically with the centrosymmetric sixth terminal seat 330-1. In addition, the centrosymmetric latch opening 347-1 is formed vertically below the centrosymmetric engagement cavity 380-1.

That is to say, as shown in FIG. 2, the centrosymmetric fourth terminal seat 310-1, the centrosymmetric fifth terminal seat 320-1, the centrosymmetric sixth terminal seat 330-1, the centrosymmetric engagement cavity 380-1 and the centrosymmetric latch opening 347-1 are symmetric to the fourth terminal seat 310, the fifth terminal seat 320, the sixth terminal seat 330, the engagement cavity 380 and the latch opening 347 with the second connector center 303.

Therefore, a second power connector 300 may connect two first power connectors 200. One of the two first power connectors 200 is rotated about 180 degrees with the other one of the two first power connectors 200.

In one or more embodiments of the present disclosure, the intermediate partition wall 345 further includes two protrusions 346 formed on both sides of the intermediate partition wall 345 and aligned to the isolation cavity 390.

In one or more embodiments of the present disclosure, a width 404 of the second power connector 300 is less than 30 mm, e.g. 26.5 mm, a height of the second power connector 300 is between 35 and 40 mm, e.g. 39 mm, and a protruding length is less than 20 mm, e.g. 14.3 mm. Therefore, the second power connector 300 is conveniently utilized in a server rack of 1U or above.

As shown in FIGS. 4 and 6, the second power connector 300 further includes a shrapnel stopping pin 410 and an opening 420. The opening 420 is formed on the rear body 302, and the shrapnel stopping pin 410 is inserted into the opening 420. In addition, the fourth terminal set 312 is fixed in the fourth terminal seat 310 and inserted into the fourth terminal passage 314, the fifth terminal set 322 is fixed in the fifth terminal seat 320 and inserted into the second terminal passage 324, and the sixth terminal set 332 is fixed in the sixth terminal seat 330 and inserted into the sixth terminal passage 334.

As shown in FIG. 6, the fourth terminal set 312 is taken as an example to illustrate the second terminal set. The fourth terminal set 312 includes a second terminal 610 and a shrapnel 620, and the shrapnel stopping pin 410 may block the shrapnel 620 to prevent the shrapnel 620 from sliding in the second power connector 300 especially when the first power connectors 200 is inserting into or removing from the second power connector 300.

In addition, an end wall 348 is formed on the rear side of the engagement cavity 380 to seal the rear side of the engagement cavity 380, but not limited thereto. The end wall 348 may further include an opening communicating with the engagement cavity 380 without departing from the scope or spirit of the present disclosure.

Furthermore, a rear end surface 402 of the rear body 302 for the fourth terminal set 312 is shorter than the rear end surface 403 of the rear body 302 for the fifth terminal set 322 and the sixth terminal set 332 about a distance 401, e.g. 5 mm. Therefore, at least a portion of the fourth terminal set 312 is exposed outside the rear body 302, and the fifth terminal set 322 and the sixth terminal set 332 are hidden in the rear body 302. A conductive wire may be connected to the fourth terminal set 312 from the left direction, the right direction, the top direction and the rear direction without departing from the scope or spirit of the present disclosure.

According to another aspect of the present disclosure, a power connector set 100 is provided. The power connector set 100 includes a second power connector 300 and at least one first power connector 200, e.g. two first power connectors 200, configured to be connected with the second power connector 300. One first power connectors 200 is inserted into the second power connector 300 in the forward direction and another one first power connectors 200 is inserted into the second power connector 300 in the reverse direction.

In addition, the latch hook 247 is accommodated in the latch opening 347 and below the outer surface of the second outer wall 340 about a distance 501, e.g. 0.9 mm, when the first power connector 200 is inserted into the second power connector 300.

Accordingly, the power connector set according to some embodiments of the present invention can utilize in a server rack, especially a server rack of 1U or above, to provide more power with high current to the required electronic devices.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A first power connector, comprising:
a housing, a front portion of the housing having a first outer wall surrounding three terminal seats and a partition wall, the partition wall and the first outer wall defines a retraction tunnel, the housing having a latch one piece formed with the first outer wall, the latch is formed as part of the first outer wall defining the retraction tunnel and is adopted to be sunk into the retraction tunnel when an external force is applied thereto; and
three terminals, being secured in the three terminal seats respectively, the retraction tunnel has no terminal disposed therein.

2. The first power connector of claim 1, wherein the partition wall substantially isolates the retraction tunnel from the three terminal seats.

3. The first power connector of claim 2, wherein the partition wall is substantially L-Shaped and connected to an inner corner of the first outer wall to form the retraction tunnel.

4. The first power connector of claim 3, wherein the partition wall is one piece formed with the first outer wall, defines a substantially rectangular shaped retraction tunnel.

5. The first power connector of claim 4, wherein the three terminal seats comprise a first terminal seat, a second terminal seat and a third terminal seat, wherein the first terminal seat and the second terminal seat are arranged vertically aligned, with the terminal in the first terminal seat being a ground terminal and the terminal in the second terminal seat being a live terminal, the third terminal seat and the retraction tunnel are arranged vertically, a width of the retraction tunnel occupies more than 40% of a width of the front portion of the housing, a width of an opening of the retraction tunnel is at least three times of a height thereof.

6. The first power connector of claim 5, wherein, the housing of the first power connector has a partition wall, extending inwardly from the first outer wall for separating at least two terminal seats of the three terminal seats and increasing a climbing distance between the terminals disposed therein respectively.

7. The first power connector of claim 5, wherein, front end surfaces of the first terminal seat, the second terminal seat, the third terminal seat, and the partition wall are coplanar and are connected to the first outer wall respectively on the same plane.

8. The first power connector of claim 2, wherein, the front portion of the first power connector has a width of 15 to 23 mm, and a height of 13 to 16 mm.

9. A cable harness, comprising:
the first power connector as recited in claim 2;
a cable, having a plurality of wires, electricity connected with the terminals respectively;
an overmolded piece, covering at least a portion of a rear portion of the housing and the cable, a rear end of the latch being not covered by the overmolded piece.

10. A second power connector, comprising:
a housing, having a front portion of the housing having a second outer wall, three terminal seats and at least two partition walls, the second outer wall surrounding all three of the terminal seats and both of the partition walls, one of the partition walls extending vertically and the other of the partition walls extending horizontally from a first terminal seat of the three terminal seats, wherein the partition walls and the second outer wall defines an engagement cavity,
the vertically extended partition wall blocks only a portion of a space between the engagement cavity and the first terminal seat, the horizontally extended partition wall blocks only a portion of a space between the engagement cavity and a third terminal seat of the three terminal seats, the first terminal seat and a second terminal seat of the three terminal seats are arranged vertically aligned, and the third terminal seat and the engagement cavity are arranged vertically,
front end surfaces of the three terminal seats and the partition walls are coplanar and are not connected to the second outer wall respectively on the same plane;
three terminals, being secured in the three terminal seats respectively.

11. The second power connector of claim 10, further comprising:
a third partition wall;
a fourth partition wall; and
an isolation cavity located between the third partition wall and the fourth partition wall.

12. The second power connector of claim 11, wherein the second outer wall comprises a first side wall, a second side wall connected to the first side wall, a third side wall connected to the second side wall, a fourth side wall connected to the third side wall to form a rectangular outer wall.

13. The second power connector of claim 12, wherein the second outer wall further comprises an intermediate partition wall connected between the second side wall and the fourth side wall.

14. The second power connector of claim 13, wherein the intermediate partition wall further comprises a protrusion formed on the intermediate partition wall and aligned to the isolation cavity.

15. The second power connector of claim 12, wherein the first side wall further comprises a latch opening formed vertically above the engagement cavity.

16. The second power connector of claim 10, further comprising:
three centrosymmetric terminal seats located in the second outer wall; and
a centrosymmetric engagement cavity located between the second outer wall and the three centrosymmetric terminal seats.

17. The second power connector of claim 16, wherein a width of the second power connector is less than 30 mm, a height of the second power connector is between 35 and 40 mm, and a protruding length is less than 20 mm.

18. The second power connector of claim 10, further comprising an end wall formed on a rear side of the engagement cavity to seal the rear side of the engagement cavity.

19. A power connector set, comprising:
a second power connector comprising:
a housing, having a front portion of the housing having a second outer wall, three terminal seats and at least two partition walls, the second outer wall surrounding all three of the terminal seats and both of the partition walls, one of the partition walls extending vertically and the other of the partition walls extending horizontally from a first terminal seats,
the partition walls and the second outer wall defines an engagement cavity,
the vertically extended partition wall blocks only a portion of a space between the engagement cavity and a first terminal seat of the three terminal seats, the horizontally extended partition wall blocks only a portion of a space between the engagement cavity and a third terminal seat of the three terminal seats, the first terminal seat and a second terminal seat of the three terminal seats are arranged vertically aligned, and the third terminal seat and the engagement cavity are arranged vertically,
front end surfaces of the three terminal seats and the partition walls are coplanar and are not connected to the second outer wall respectively on the same plane; and
three terminals, being secured in the three terminal seats respectively; and
a first power connector configured to be connected with the second power connector.

20. The power connector set of claim 19, further comprising another first power connector configured to be connected with the second power connector, wherein the first power connector is inverted with the another first power connector.
